(19) United States
(12) Patent Application Publication
(10) Pub. No.: US 2025/0198853 A1
(43) Pub. Date: Jun. 19, 2025

(54) FLEXIBLE SENSOR UNIT FOR MEASURING TEMPERATURE AT POWER CONTACTS FOR E-MOBILITY

(71) Applicant: Yageo Nexensos GmbH, Kleinostheim (DE)

(72) Inventors: Mario Sattler, Kleinostheim (DE); Matthias Muziol, Kleinostheim (DE); Martin Bleifuss, Kleinostheim (DE); Bastian Schwappach, Kleinostheim (DE); Hengshi Xiang, Min Hang Qu (CN); Christoph Nick, Kleinostheim (DE)

(21) Appl. No.: 18/836,535

(22) PCT Filed: Feb. 15, 2015
(86) PCT No.: PCT/EP2023/053735

§ 371 Date: Aug. 7, 2024

(30) Foreign Application Priority Data
Mar. 10, 2022 (EP) 22161239.3

(51) Int. Cl. G01K 7/16; G01K 1/14

(52) U.S. Cl. CPC G01K 7/16; G01K 1/14

(57) ABSTRACT

A temperature sensor having an insulating polymer substrate, at least two connection lines and at least one resistance sensor element, the at least two connection lines being arranged on the polymer substrate, the at least one resistance sensor element being connected to the connection lines and the at least one resistance sensor element and the connection lines being covered at least partially by a cover layer having a flexible polymer. The Further included are a plug-in connection element having the temperature sensor and an automated method for producing the plug-in connection element.

### CROSS REFERENCE TO RELATED PATENT APPLICATIONS

This is a U.S. national phase patent application of PCT/EP2023/053735 filed Feb. 15, 2023 which claims the benefit of and priority to European Patent Application No. EP 22161239.3, filed on Mar. 10, 2022, the entire contents of each of which are incorporated herein by reference for all purposes.

### TECHNICAL FIELD

The invention pertains to a temperature sensor having a resistance sensor element, particularly a platinum resistance sensor element that is arranged between an insulating polymer substrate and a cover layer comprising a flexible polymer. The invention furthermore pertains to a plug-in connection element having a metallic conduction element, on which the temperature sensor is arranged, as well as to an automated method for producing this plug-in connection element.

### BACKGROUND

Plug-in connection elements for charging batteries, e.g. for electric vehicles (trucks or passenger cars), have to conduct very high currents. Excessively high currents or poor contacting can cause the charging plug to heat up and, in the worst case, lead to the destruction of the plug or components connected thereto. This is the reason why charging plugs or charging sockets typically have temperature sensors that measure whether the operating temperature lies within the predefined range. For reasons of simplicity, the term charging plug may in the following description refer to the charging plug itself, as well as to the charging socket. When the temperature of the charging plug exceeds a predefined value, the charging power is adjusted downward or the charging process is interrupted in order to prevent damages and to ensure a high level of safety for the user.

In order to allow fast responding behavior, the temperature sensor preferably should be arranged directly on the conduction element of the charging plug such that the temperature is measured directly at the location, at which high currents are conducted or flow across boundary surfaces and coupling regions. Temperature sensors according to the prior art frequently are arranged at a distance from the conduction element in a mounting and the actual temperature at the conduction element is extrapolated. One example of such a construction can be found in WO2020065449A1.

In order to allow a less expensive production of charging connections, it would be desirable to automate the production of charging plugs with integrated temperature monitoring. However, the currently available temperature sensors are not sufficiently suitable for an automated production of charging plugs. The connection lines of the sensors particularly are realized in the form of exposed flexible wires, which makes automated processing more difficult. Automated assembly methods are in fact known from other technical fields. In production lines such as in the semiconductor industry, it is common practice to use temperature sensors that are mounted on a conveyor belt (also referred to as blister belt), wherein said temperature sensors are taken hold of by a gripping robot and placed at the desired location in the component. This process is established and particularly used in the assembly of PCBs with SMD temperature sensors. However, such a direct placement of an SMD temperature sensor in or on a conduction element of a charging plug by means of a pick-and-place robot is complicated or not possible because the SMD temperature sensor typically is arranged in a depression in a pin or the socket. These depressions are difficult to access for automated gripping robots.

Contacting of the sensor after the positioning in or on the conduction element represents another challenge. It would be desirable to realize the contacting of the temperature sensor in the charging plug without movable wires and cables. Temperature sensors that are already provided with connection wires are currently already installed in charging plugs. These connection wires are inserted into a receptacle in the conduction element of the charging plug and fixed therein. Contacting of the connection wires subsequently takes place. However, this concept is difficult to transfer into an automated process. Most of the sensors used have an excessive mechanical rigidity and the position of the movable connection wires fluctuates excessively. It is therefore complicated to contact the loose ends of the connection wires in an automated process.

Another aspect that has to be taken into account in the arrangement of temperature sensors on conduction elements of a charging plug is the electrical insulation. The potential difference between the temperature-monitored plug-in connection element and the housing may be as high as 1000 V. It is therefore challenging to ensure the electrical insulation of the sensor against the conduction element, to which a high potential is applied.

### SUMMARY

In light of the problems associated with the prior art, the invention aims to make available a temperature sensor that eliminates at least one of the problems of the prior art. The invention particularly aims to make available a temperature sensor that is as flat as possible, flexible and well insulated against electrical breakdown. The temperature sensor should at the same time allow the highest measuring precision possible.

Another objective of the invention can be seen in making available a temperature sensor that can be installed in a charging plug in an automated process.

The invention also aims to make available a plug-in connection element, in which the temperature can be measured as close as possible to the conduction element.

The invention furthermore aims to make available a method that reduces the production effort for the production of plug-in connection elements and makes it possible to forgo manual steps.

At least one objective is attained with the respective subject matter shown and disclosed herein.

According to a first aspect, the invention pertains to a temperature sensor having an insulating polymer substrate, at least two connection lines and at least one resistance sensor element, wherein the at least two connection lines are arranged on the polymer substrate, wherein the at least one resistance sensor element is connected to the connection lines, and wherein the at least one resistance sensor element and the connection lines are covered at least partially by a cover layer comprising a flexible polymer.

The temperature sensor has an insulating polymer substrate. The insulating polymer substrate is an electrically insulating polymer substrate and preferably has a dielectric strength of at least 100 KV/mm, particularly at least 300 KV/mm. The material of the insulating polymer substrate may be selected, for example, from the group comprising silicones, polyimides, parylenes and epoxides. The insulating polymer substrate may optionally comprise other components such as intermediate layers of metal, adhesives and/or additives and/or fillers for improving the thermal conductivity.

The thickness of the insulating polymer substrate lies in the range between 10 μm and 300 μm, preferably in the range between 25 μm and 100 μm. In a preferred embodiment, the insulating polymer substrate has a width in the range between 2 mm and 20 mm and a length in the range between 20 mm and 100 mm. The insulating polymer substrate may have any shape deemed feasible by a person skilled in the art. For example, the insulating polymer substrate may have perforations, openings or recesses. In another potential embodiment, the polymer substrate may have reinforcement structures such as flat wires, which can ensure additional stabilization, e.g. against twisting. It may alternatively contain additional structures such as metal wires, which make it possible to fix the produced temperature sensor in a curved installation position.

In a preferred embodiment, an adhesive, particularly a pressure sensitive adhesive, is present on at least one side of the insulating polymer substrate, particularly in the form of a layer or a full-surface layer.

The temperature sensor furthermore has at least two connection lines. The connection lines are arranged on the insulating polymer substrate. Each of the connection lines typically has a landing pad for contacting a resistance sensor element and a terminal pad for contacting another component, e.g. a circuit board. The landing pad and the terminal pad usually are arranged on opposite ends of a connection line and electrically connected to one another by this connection line.

The connection lines, the landing pads and the terminal pads respectively have a thickness of no more than 50 μm. The minimum thickness typically amounts to 5 μm. The landing pads and the terminal pads may respectively form part of the connection line or be applied subsequently in one or more steps. For example, the landing pads and the terminal pads may be applied by means of printing, vapor-deposited or deposited galvanically.

The connection lines are arranged, particularly fixed, on the insulating polymer substrate. The connection lines preferably comprise or consist of a metal. The metal of the connection lines preferably can be selected from the group comprising copper, silver, gold, platinum, palladium, tin, nickel and iron, as well as mixtures thereof.

The at least two connection lines may be connected to the insulating polymer substrate integrally or frictionally. The connection lines may be produced in different ways. It is possible, for example, to produce the connection lines of structured foils, wherein the thusly produced connection lines are subsequently arranged on the insulating polymer substrate and laminated by means of a cover layer. According to another alternative, the connection lines may be produced of a thin metal layer that initially is applied on the insulating polymer substrate in a laminar manner, e.g. by means of PVD or CVD, and subsequently structured so as to form connection lines, e.g. with the aid of a laser or by means of etching or milling. Furthermore, the connection lines may be printed of a composition containing metal, e.g. by means of screen printing. If applicable, combinations of the aforementioned methods may also be used for producing the connection lines.

According to the invention, the temperature sensor has at least two connection lines. The temperature sensor may optionally also have three, four, five or more connection lines. In a particularly preferred embodiment, the temperature sensor has four connection lines for reading out the sensor by means of a four-point circuit.

The connection lines preferably are arranged on the insulating polymer substrate in such a way that the terminal pads point toward the edge of the insulating polymer substrate. It is particularly preferred that the terminal pads extend up to an edge of the insulating polymer substrate. This allows particularly simple contacting of the terminal pads, e.g. on a circuit board.

In a potential embodiment, the connection lines are flattened on their edges such that a cover layer, particularly in the form of a film, can cover the connection lines as conformally as possible, i.e. in a tightly fitting manner.

The temperature sensor has at least one resistance sensor element that preferably is selected from the group comprising a metal-based or semiconductor-based PTC, a metal-based or semiconductor-based NTC and a KTY.

The at least one resistance sensor element preferably has a metallic strip conductor. The strip conductor may have any structure. For example, the strip conductor has a meander structure. The metallic strip conductor preferably contains or consists of a metal. The metal of the strip conductor preferably can be selected from precious metal and non-precious metals. Precious metals may be selected from the group comprising gold, silver, platinum, palladium, rhodium and iridium.

Non-precious metals may be selected from the group comprising aluminum, copper and nickel.

The metal may comprise or consist of an elementary metal or an alloy.

In a preferred embodiment, the metal is an alloy. The alloy may contain a precious metal that is selected from the group comprising gold, silver, platinum, palladium, rhodium and iridium. The alloy preferably contains two or more precious metals. For example, the alloy may be a silver alloy or a silver-platinum alloy. In another embodiment, the alloy may comprise at least one precious metal and at least one non-precious metal. The alloy may optionally comprise precious metal, as well as non-precious metal. It is furthermore possible that the alloy comprises non-metals.

The metallic strip conductor in the resistance sensor element preferably is arranged, particularly integrally fixed, on an organic or an inorganic carrier. The organic carrier may contain a polymer. The inorganic carrier may comprise a glass, a semiconductor such as silicon or a ceramic. The ceramic carrier may comprise or consist of an oxide ceramic such as aluminum oxide or silicon oxide.

It is particularly preferred that the resistance sensor element is a platinum resistance sensor, particularly a PT100, a PT1000 or a PT2500, i.e. a platinum resistance sensor with a respective nominal resistance of 100 Ohm, 1000 Ohm or 2500 Ohm.

Platinum resistance sensors have the advantage of a high measuring accuracy, a straight characteristic in a broad temperature range and a high stability.

It is particularly preferred that the resistance sensor element is realized in the form of the surface-mountable component (i.e. in accordance with SMD technology). To this end, the opposite ends of the resistance sensor element may have metal platings. Resistance sensor elements in accordance with SMD technology may be arranged on landing pads, for example, in flip-chip configuration.

The resistance sensor element preferably has a thickness of at least 30 μm or at least 50 μm. Furthermore, the resistance sensor element preferably has a thickness of no more than 700 μm. A thin resistance sensor element is advantageous because a cover layer arranged thereon can cover the resistance sensor element without producing large gas inclusions. In this context, we refer, for example, to area A in FIG. 2. The thickness preferably is measured perpendicular to the surface, on which the metallic strip conductor of the resistance sensor element is arranged. The preferred lengths and widths of the resistance sensor element lie in the range between 0.3 mm and 4 mm.

The resistance sensor element is connected to the at least two connection lines. The resistance sensor element preferably contacts the at least two connection lines via a respective landing pad. In an optional embodiment of the invention, the resistance sensor element may be arranged on a printed landing pad before the landing pad is sintered.

The at least one resistance sensor element and the connection lines are covered at least partially by a cover layer. The cover layer comprises a flexible polymer. It is preferred that the entire surface of the resistance sensor element is covered with the cover layer. It is furthermore preferred that the respective terminal pad of the at least two connection lines remains exposed. The cover layer preferably is designed for encapsulating the resistance sensor element, particularly hermetically. To this end, the cover layer preferably is bonded or welded to the insulating polymer substrate, the connection lines and the resistance sensor element. The adhesive used may be a temperature-resistant hot-melt adhesive, a pressure sensitive adhesive or a bi-staged adhesive. The adhesive used for the bonding process furthermore may be arranged on the insulating polymer substrate over its entire surface or partially. The adhesive used for bonding the cover layer to the insulating polymer substrate may either be arranged on the insulating polymer substrate or on the cover layer.

In a preferred embodiment of the invention, the cover layer comprises the same material as the polymer substrate. The cover layer optionally is a polymer film, particularly a polyimide film. Alternatively, the material of the cover layer may differ from the material of the polymer substrate. The cover layer preferably has a thickness that lies in the range between 5 μm and 50 μm.

A very high dielectric strength can be achieved due to the encapsulation of the resistance sensor element with the cover layer, which particularly contains polyimide, such that a temperature measurement can be realized on or even in the interior of a metallic conduction element of a plug-in connection element. In contrast, a temperature sensor in a charging plug according to the prior art typically is positioned at a distant location of the plug, e.g. in the housing, and therefore not as directly.

The overall thickness of the temperature sensor comprising the polymer substrate, the resistance sensor element and the cover layer preferably lies in the range between 10 μm-1500 μm. The finished temperature sensor preferably is flexible.

In addition, the insulating polymer substrate may have an adhesive layer and/or a metal layer on the surface that does not have any connection lines.

Depending on its design, the temperature sensor may have a temperature resistance in the range between −196° C. and +270° C. It can even withstand temperatures of up to 400° C. for a short time.

The inventive temperature sensor preferably can be produced in a roll-to-roll process. The roll-to-roll process may take place as follows.

The insulating polymer substrate is unwound from a roll in the form of a strip. A plurality of connection lines is applied and particularly fixed on the insulating polymer substrate in strip form. This is realized, for example, by means of printing or by structuring a thin metal layer with the aid of lithographic methods. For example, the printing process may be a screen printing process, in which a thick film paste containing metal is used. The applied structures may be subjected to a subsequent treatment depending on the respective requirements. In the case of a screen printing process, the strip conductors can be sintered in order to achieve the conductivity.

In the next step, the polymer substrate with the connection lines previously arranged thereon is fitted with resistance sensor elements. If the resistance sensor elements are realized in accordance with SMD technology, the resistance sensor elements can be processed in a pick-and-place process, particularly an automated pick-and-place process.

Subsequently, the resistance sensor elements are integrally connected, particularly soldered, bonded or sintered, to the connection lines by means of the landing pads. To this end, the connecting material, i.e. an adhesive, a soldering material or a sintering material, may be applied either on the resistance sensor element or on the landing pads. If a solder or a sintering material is used, a temperature treatment may be required for converting the connecting material into a mechanically and electrically solid connection. A reflow process may be used if the resistance sensor element is connected by means of soldering.

A cover layer, e.g. in the form of a polymer film, particularly a polyimide film, is supplied in the next step. The cover layer may optionally be supplied in the form of a continuous strip being unwound from a roll.

The cover layer is brought in contact with the insulating polymer substrate, which preferably is likewise realized in the form of a strip, such that it covers the at least one resistance sensor element completely and the connection lines at least partially. Subsequently, the cover layer is connected, particularly welded or bonded, to the insulating polymer substrate. The welding process for connecting the cover layer and the insulating polymer substrate to one another may be carried out, for example, with a heated die stamp or a roller. The welding process particularly takes place in the edge region around the resistance sensor element.

The aforementioned steps make it possible to obtain a composite structure of temperature sensors, wherein the temperature sensors are arranged on a contiguous insulating polymer substrate.

In a potential embodiment, the composite structure of multiple temperature sensors is subsequently wound up so as to form a roll. In this way, the composite structure of temperature sensors can be easily and carefully transported. Furthermore, the composite structure of temperature sensors can be unwound again and the sensors can be singulated for further processing.

In another embodiment, the temperature sensors in the form of a composite structure are not wound up after the application of the cover layer, but rather directly singulated. The singulation may be realized, for example, by means of cutting or punching.

According to a second aspect, the invention pertains to a plug-in connection element that is selected from a plug and a socket. The plug-in connection element usually is connected to a cable, particularly a power cable. The plug-in connection element preferably forms part of a plug-in connection consisting of a plug and the complementary socket. The plug-in connection element has at least one metallic conduction element for conducting electric current. The term conduction element refers to the component, by means of which the plug-in connection element is in contact with another plug-in connection element, e.g. by means of which the plug is electrically connected to the socket. This is usually also the component, through which the highest currents flow. In the case of a plug, the metallic conduction element may also be referred to as a pin.

In addition, a plug-in connection element usually has a housing, in which the metallic conduction element is fixed in an electrically insulating manner. The housing usually also encloses the connection of the conduction element to other components, e.g. a cable.

The metallic conduction element has a surface. An inventive temperature sensor is arranged on this surface. The temperature sensor can be fixed on the conduction element by means of an integral, form-fitting or frictional connection. The inventive temperature sensor may be directly in contact with the metallic conduction element, i.e. by means of the insulating polymer substrate or the cover layer or both. In this context, directly means that no additional materials are arranged between the temperature sensor and the metallic conduction element. Alternatively, a connecting material may be arranged between the metallic conduction element and the temperature sensor. The connecting material may be an adhesive, particularly a thermally conductive adhesive or a thermally conductive paste. The adhesive preferably can serve for mechanically fixing the temperature sensor on the surface of the metallic conduction element. It is furthermore advantageous that the adhesive has a high thermal conductivity. A thermally conductive paste preferably serves for improving the thermal connection of the temperature sensor to the surface.

In another preferred embodiment, the metallic conduction element may have a depression on the surface. The depression preferably is realized in such a way that it can accommodate the temperature sensor partially or completely. In one embodiment of the invention, the depression is designed for accommodating the temperature sensor flatly, i.e. such that either the insulating polymer substrate or the cover layer mechanically contacts the surface of the metallic conduction element. In another embodiment, the depression is designed in the form of a slot. In this case, the temperature sensor can be inserted into the slot similar to the insertion of a letter into a mailbox. The slot preferably is so deep that the resistance sensor element of the temperature sensor can be recessed into the slot. In this way, particularly sound thermal coupling of the temperature sensor to the metallic conduction element can be achieved. In another variation, the depression may be a round borehole. The temperature sensor can be inserted into this borehole, e.g. in a bent manner, and cling to the inner wall of the borehole due to its spring effect. A slot-shaped depression preferably is arranged in the metallic conduction element along the current conducting direction in order to prevent an unnecessary reduction of the conductor cross-section and an impairment of the heat flow, as well as to allow a homogenous temperature distribution in the metallic conduction element.

In a preferred embodiment, the plug-in connection element has a circuit board. The circuit board preferably has at least two connections. The circuit board may be a printed circuit board (PCB). Other components may be arranged on the circuit board. A circuit board fitted with electronic components may also be referred to as a circuit board assembly. The components may be electronic components such as semiconductor components or logical circuits.

The measured resistance values can be additionally processed with the aid of logic components, e.g., in order to initiate other actions such a reduction of the charging current upon overheating of the plug-in connection element in a charging plug.

The connection lines of the temperature sensor contact the circuit board. It is particularly preferred that the circuit board is contacted directly, i.e. without additional wires or cables. Contacting of the circuit board may be realized in an integral, form-fitting or frictional manner. This contacting particularly is realized by means of the terminal pads of the connection lines. In the case of an integral connection, the terminal pads may be connected to at least two connections of the circuit board, for example, by means of a soldered connection, a sintered connection, a welded connection or an electrically conductive adhesive connection. It is alternatively also possible to connect the connection lines to the circuit board by means of plug-type connectors.

It is particularly advantageous that the temperature sensor is flexible such that the region containing the connection lines can be bent toward the circuit board or toward the contacts of the circuit board. This can eliminate the need for wires or cables.

According to a third aspect, the invention pertains to an automated method for producing multiple plug-in connection elements according to the invention, wherein said method is characterized in that multiple inventive temperature sensors are supplied in the form of a composite structure of interconnected temperature sensors. The composite structure preferably can be a wound up strip of interconnected temperature sensors.

The composite structure can be unwound in the next step. Subsequently, a temperature sensor of the composite structure either can be separated from the composite structure in order to be arranged on a metallic conduction element in the form of a singulated temperature sensor or the temperature sensor is conveyed to the metallic conduction element of the plug-in connection element as part of the composite structure in order to be singulated at this location or in the vicinity of the surface.

The singulated temperature sensor being supplied preferably is arranged on the surface of the metallic conductor element by means of automatic assembly. This allows high precision and high reproducibility in the production of plug-in connection elements.

It is furthermore preferred that the connection lines are electrically connected to the circuit board. This is preferably realized by means of the terminal pads of the connection lines. This connection particularly is also produced with the aid of an automated process. This is possible, in particular, due to the fact that the connection lines, which optionally have terminal pads, are fixed on the insulating polymer substrate in the temperature sensor. This contradicts temperature sensors according to the prior art, in which the connection lines are realized in the form of wires that freely protrude from a sensor element.

Subsequently, the singulated temperature sensor optionally is fixed in an integral, frictional or form-fitting manner. Integral fixing preferably is realized by means of bonding. A frictional connection is produced, for example, by means of clips.

In another potential embodiment, multiple inventive temperature sensors may be supplied in the form of a composite structure and a temperature sensor of the composite structure is conveyed to the surface of the conduction element as part of the composite structure. The temperature sensor can then be directly singulated and fixed on the surface at this location. The positioning therefore is realized by means of the composite structure of temperature sensors. Fixing can be achieved, for example, by using a thermally conductive adhesive. The temperature sensor may alternatively be fixed in a form-fitting or frictional manner, e.g. by means of clips.

### BRIEF DESCRIPTION OF THE FIGURES

FIG. 1 shows a schematic representation of a temperature sensor in the form of a top view.

FIG. 2 shows a schematic representation of a temperature sensor in the form of a cross section.

FIG. 3 shows a perspective representation of a plug-in connection element in the form of a plug pin, into which a temperature sensor is recessed.

FIG. 4 shows a schematic representation of a plug-in connection element in the form of a charging plug socket, on which a temperature sensor is arranged.

### DESCRIPTION OF AN EMBODIMENT

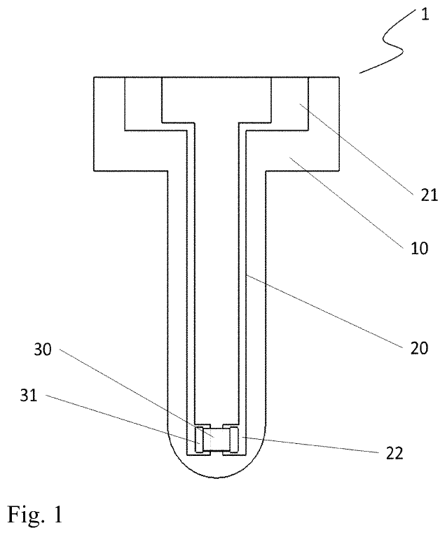

FIG. 1 shows a top view of a temperature sensor (1). Two connection lines (20) are arranged on an insulating polymer substrate (10). The connection lines (20) respectively comprise a terminal pad (21) and a landing pad (22). A resistance sensor element (30) is arranged on the landing pads (22) of the connection lines (20) and connected to the landing pads by means of connective metal platings (31).

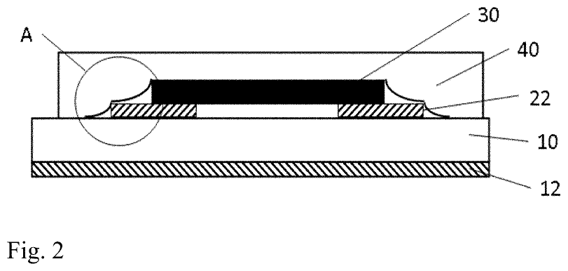

FIG. 2 shows a cross section through a temperature sensor (1) in the region of the resistance sensor element (30). A resistance sensor element (30) is arranged on the insulating polymer substrate (10). The resistance sensor element (30) is covered with a cover layer (40). The cover layer (40) preferably is connected to the insulating polymer substrate (10) in such a way that the resistance sensor element is hermetically encapsulated and thereby protected against environmental influences. FIG. 2 shows a preferred embodiment, in which the cover layer (40) preferably is arranged on the resistance sensor element (30) and the insulating polymer substrate (10) in a form-fitting manner. In this way, the hollow space in the transition region (A) can be as small as possible. This embodiment particularly can be realized if the resistance sensor element (30) is designed as thin as possible, e.g. with a height of approximately 50 μm, particularly approximately 30 μm. The insulating polymer substrate (10) optionally has a metal plating (12) on the side lying opposite of the side with the resistance sensor element (30). For example, the metal plating (12) can ensure an improved thermal connection.

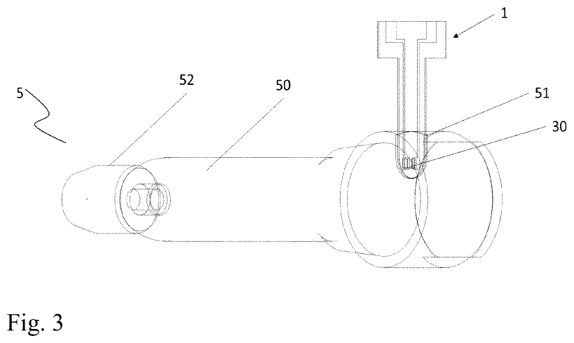

FIG. 3 shows a plug-in connection element (5), which in this example is realized in the form of a pin. The conduction element (50) has a depression (51). The temperature sensor (1) is inserted into the depression (51). In this case, the resistance sensor element (30) is completely integrated within the conduction element (50). In the example shown, the conduction element (50) has a protective cap (52) that can prevent inadvertent contacting of the conduction element (50) when it is arranged in a plug or a socket.

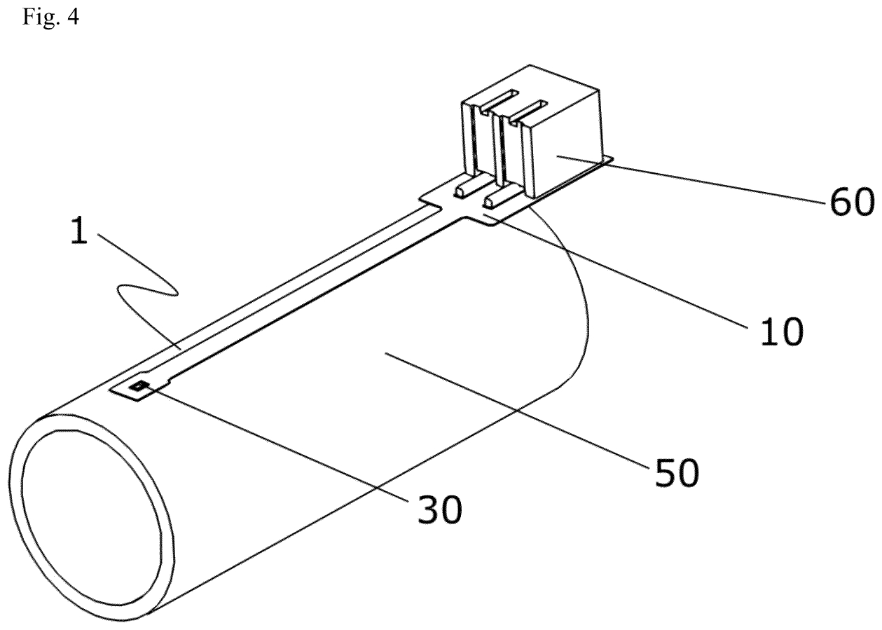

FIG. 4 schematically shows a conduction element (50) in the form of a sleeve, particularly in the form of a charging plug socket. The sleeve serves for receiving a current-carrying plug pin. A temperature sensor (1) is arranged on the surface of the sleeve in direct thermal contact with the sleeve. The resistance sensor element (30) of the temperature sensor (1) preferably is located near the region of the sleeve, in which the highest temperature occurs during the charging process. The temperature sensor comprises an insulating polymer substrate (e.g. of polyimide), four (not-shown) connection lines and a resistance sensor element (30) in the form of a flexible 2.5° kOhm SMD flip-chip. The SMD flip-chip is electrically connected to the four landing pads, which respectively form one end of the connection lines, such that a four-point circuit can be realized. The four terminal pads on the other end of the connection lines (20) are connected to a plug clip (60). The insulating polymer substrate (10) is covered with a cover layer (40), wherein the cover layer (40) comprises a polyimide layer that is coated with a pressure sensitive adhesive. The cover layer (40) covers the resistance sensor element (30) completely and the connection lines (20) up to the plug clip (60). For example, the total thickness of the temperature sensor (1) in the region of the resistance sensor element (30) amounts to 250°μm.

### LIST OF REFERENCE SYMBOLS

1 Temperature sensor
5 Plug-in connection element
10 Insulating polymer substrate
12 Adhesive layer
20 Connection line
21 Terminal pad
22 Landing pad
30 Resistance sensor element
31 Connective metal platings
40 Cover layer
50 Conduction element
51 Depression
52 Protective cap
60 Plug clip
A Transition region

1-16. (canceled)

17. A temperature sensor comprising:
an insulating polymer substrate;
at least two connection lines; and
at least one resistance sensor element, wherein the at least two connection lines are arranged on the insulating polymer substrate, wherein the at least one resistance sensor element is connected to the at least two connection lines, and wherein the at least one resistance sensor element and the at least two connection lines are covered at least partially by a cover layer comprising a flexible polymer.

18. The temperature sensor according to claim 17, wherein the at least one resistance sensor element has a conductive metallic resistance structure that comprises platinum.

19. The temperature sensor according to claim 17, wherein the insulating polymer substrate has a dielectric strength of at least 100 KV/mm.

20. The temperature sensor according to claim 17, wherein the at least two connection lines are integrally connected to the insulating polymer substrate.

21. The temperature sensor according to claim 17, wherein the at least one resistance sensor element is realized in accordance with surface-mountable technology.

22. The temperature sensor according to claim 17, wherein the temperature sensor has a thickness in a range between 10 μm-1500 μm.

23. A plug-in connection element selected from a plug and a socket, wherein the plug-in connection element has at least one metallic conduction element for conducting an electric current, and wherein the temperature sensor according to claim 17 is arranged on the surface of the metallic conduction element.

24. The plug-in connection element according to claim 23, wherein the at least one metallic conduction element has a depression and the temperature sensor is arranged in the depression.

25. The plug-in connection element according to claim 24, wherein the depression is a slot, into which a region of the temperature sensor containing the at least one resistance sensor element is completely recessed.

26. The plug-in connection element according to claim 23, further comprising a circuit board, wherein the at least two connection lines of the temperature sensor contact the circuit board without use of wires or cables.

27. The plug-in connection element according to claim 26, wherein the at least two connection lines of the temperature sensor contact the circuit board by an integral, form-fitting or frictional connection.

28. The plug-in connection element according to claim 27, wherein the integral connection is selected from the group comprising a soldered connection, a sintered connection, a welded connection, and a conductive adhesive connection.

29. The plug-in connection element according to one of claim 23, wherein the temperature sensor is fixed on the at least one metallic conduction element by an integral, form-fitting or frictional connection.

30. An automated method for producing multiple ones of the plug-in connection element according to claim 23, wherein multiple ones of the temperature sensor are supplied in a form of a composite structure of interconnected temperature sensors.

31. The automated method according to claim 30, wherein the multiple ones of the temperature sensor, which are part of the composite structure, are singulated prior to an installation in the multiple ones of the plug-in connection element.

32. The automated method according to claim 31, wherein the singulated ones of the temperature sensor being supplied are arranged on the surface of the at least one metallic conduction element by an automated assembly.
